(19) United States
(12) Patent Application Publication
(10) Pub. No.: US 2013/0278679 A1
(43) Pub. Date: Oct. 24, 2013

(54) LIQUID DROPLET DISCHARGE HEAD, METHOD OF MANUFACTURING LIQUID DROPLET DISCHARGE HEAD, AND LIQUID DROPLET DISCHARGE DEVICE

(71) Applicant: SEIKO EPSON CORPORATION, Tokyo (JP)

(72) Inventors: Junichi TAKEUCHI, Chino-Shi (JP); Kiyoshi MIYAZAWA, Shiojiri-shi (JP)

(73) Assignee: SEIKO EPSON CORPORATION, Tokyo (JP)

(21) Appl. No.: 13/864,706

(22) Filed: Apr. 17, 2013

(30) Foreign Application Priority Data
Apr. 18, 2012 (JP) 2012-094518

(51) Int. Cl. B41J 2/14; B41J 2/16

(52) U.S. Cl. CPC B41J 2/1433; B41J 2/1629
USPC 347/47; 216/27

(57) ABSTRACT

In a liquid droplet discharge head, a first groove-shaped cavity is formed on a cavity plate, a second groove-shaped cavity is formed on a nozzle plate in addition to nozzle holes, when bonding the cavity plate and the nozzle plate to each other, the first groove-shaped cavity and the second groove-shaped cavity overlap to form a pressure chamber.

### BACKGROUND

1. Technical Field

The present invention relates to a liquid droplet discharge head, a method of manufacturing the liquid droplet discharge head, and a liquid droplet discharge device.

2. Related Art

A liquid droplet discharge device such as an inkjet printer has many advantages in which noise during recording is extremely small, high-speed printing is possible, ink choices vary, cheap plain paper can be used, or the like. In a liquid droplet discharge head used for the liquid droplet discharge device, in order to prevent an increase in viscosity of ink due to drying of solvent, it is preferable to increase a capacity of a pressure chamber. For example, for that, a configuration is suitably adopted in which a cavity plate formed with a cavity for a pressure chamber, a reservoir plate formed with a communicating cavity communicating with the cavity for the pressure chamber, and a nozzle plate formed with nozzle holes are sequentially stacked to form a liquid droplet discharge head, and the cavity for the pressure chamber and the communicating cavity are used as the pressure chamber (see, JP-A-2008-68617).

However, as in the configuration described in JP-A-2008-68617, in the liquid droplet discharge head in which the cavity plate, the reservoir plate and the nozzle plate formed with the nozzle holes are sequentially stacked, since the large number of members is used, the manufacturing cost thereof increase.

### SUMMARY

An advantage of some aspects of the invention is to provide a liquid droplet discharge head capable of increasing a capacity of a pressure chamber by the small number of components, a method of manufacturing the liquid droplet discharge head, and a liquid droplet discharge device.

An aspect of the invention is directed to a liquid droplet discharge head that includes a nozzle plate having nozzle holes; and a cavity plate joined to the nozzle plate, wherein a pressure chamber communicating with the nozzle holes includes a first groove-shaped cavity formed on the cavity plate, and a second groove-shaped cavity formed on the nozzle plate, and the nozzle holes communicate with a bottom portion of a concave portion of the second groove-shaped cavity.

Another aspect of the invention is directed to a method of manufacturing a liquid droplet discharge head that includes a nozzle plate having nozzle holes, a cavity plate joined to the nozzle plate, and a pressure chamber communicating with the nozzle holes, the method includes forming a first groove-shaped cavity on a substrate for the cavity plate to obtain the cavity plate; forming the nozzle holes on a substrate for the nozzle plate and forming a second groove-shaped cavity communicating with the nozzle holes on a main surface of the substrate for the nozzle plate to obtain the nozzle plate; and stacking the first groove-shaped cavity and the second groove-shaped cavity and bonding the nozzle plate and the cavity plate to each other to form the pressure chamber.

In the aspect of the invention, the first groove-shaped cavity is formed on the cavity plate, the second groove-shaped cavity is formed on the nozzle plate, in addition to the nozzle holes, and when bonding the cavity plate and the nozzle plate to each other, the first groove-shaped cavity and the second groove-shaped cavity overlap each other to form the pressure chamber. For this reason, it is possible to form the pressure chamber having the great capacity using the two members. Therefore, it is possible to prevent an increase in viscosity of the discharged liquefied substance in the pressure chamber due to the evaporation of the solvent. Furthermore, when expanding the pressure chamber in the thickness direction, although an area of the wall surface interposed between the adjacent pressure chambers increases and the crosstalk easily occurs, in the aspect of the invention, since the pressure chamber is expanded in an in-plane direction, even when the capacity of the pressure chamber is expanded, the area of the wall surface interposed between the adjacent pressure chambers is small. Therefore, in the liquid discharge head and the liquid droplet discharged device to which the aspect of the invention is applied, there is an advantage in that, even when the capacity of the pressure chamber is expanded, the crosstalk is hard to occur.

According to the aspect of the invention, it is preferable that the first groove-shaped cavity be formed by the wet etching in the forming of the cavity plate, and the nozzle holes be formed by the dry etching in the forming of the nozzle plate. In this configuration, the cavity plate can be effectively manufactured, and it is possible to manufacture the nozzle plate having the excellent shape accuracy or the like of the nozzle hole.

The aspect of the invention may be configured such that, in the forming of the nozzle plate, forming a concave portion on the main surface of the substrate for the nozzle plate by etching, forming the second groove-shaped cavity on the main surface by etching, and thinning by cutting the substrate for the nozzle plate from a back surface the substrate with respect to the main surface and perforating the concave portion as the nozzle hole are performed.

The aspect of the invention may be configured such that, in the forming of the nozzle plate, forming a concave portion on the back surface with respect to the main surface of the substrate for the nozzle plate by etching, thinning by cutting the substrate for the nozzle plate the substrate from the main surface, and forming the second groove-shaped cavity on the main surface of the substrate for the nozzle cavity by etching are performed.

### BRIEF DESCRIPTION OF THE DRAWINGS

The invention will be described with reference to the accompanying drawings, wherein like numbers reference like elements.

FIG. 1 is an explanatory view of a liquid droplet discharge device related to Embodiment 1 of the invention.

FIGS. 2A and 2B are explanatory views of a head assembly used for the liquid droplet discharge device related to Embodiment 1 of the invention.

FIG. 3 is an exploded perspective view of the liquid droplet discharge head related to Embodiment 1 of the invention.

FIG. 4 is a cross-sectional view of the liquid droplet discharge head related to Embodiment 1 of the invention.

FIGS. 5A and 5B are explanatory views of a pressure chamber formed in the liquid droplet discharge head related to Embodiment 1 of the invention.

FIGS. 6A to 6C are process cross-sectional views that show a method of manufacturing a cavity plate shown in FIGS. 5A and 5B.

FIGS. 7A to 7E are process cross-sectional views that show a first example of the method of manufacturing a nozzle plate shown in FIGS. 5A and 5B.

FIGS. 8F to 8I are process cross-sectional views that show a manufacturing process of the nozzle plate performed subsequent to FIGS. 7A to 7E.

FIGS. 9A to 9C are process cross-sectional views that show a second example of the method of manufacturing the nozzle plate shown in FIGS. 5A and 5B.

FIGS. 10D to 10I are process cross-sectional views that show a manufacturing process of the nozzle plate performed subsequent to FIGS. 9A to 9C.

FIGS. 11A to 11C are process cross-sectional views that show a third example of the method of manufacturing a nozzle plate shown in FIGS. 5A and 5B.

FIGS. 12D to 12G are process cross-sectional views that show a manufacturing process of the nozzle plate performed subsequent to FIGS. 11A to 11C.

FIGS. 13H to 13I are process cross-sectional views that show a manufacturing process of the nozzle plate performed subsequent to FIGS. 12D to 12G.

FIG. 14 is an enlarged cross-sectional view showing an aspect in which a nozzle plate of a liquid droplet discharge head related to Embodiment 2 of the invention is cut in a main scanning direction.

### DESCRIPTION OF EXEMPLARY EMBODIMENTS

Embodiments of the invention will be described referring to the drawings. In addition, in the following description, as a liquid droplet discharge device to which the invention is applied, an ink jet printer will be described as an example. Furthermore, in the following description, a main scanning direction (a direction perpendicular to a row direction of the nozzle holes) is set to an X direction, and an auxiliary scanning direction (the row direction of the nozzle holes) is set to a Y direction.

### Embodiment 1

### Overall Configuration of Liquid Droplet Discharge Device

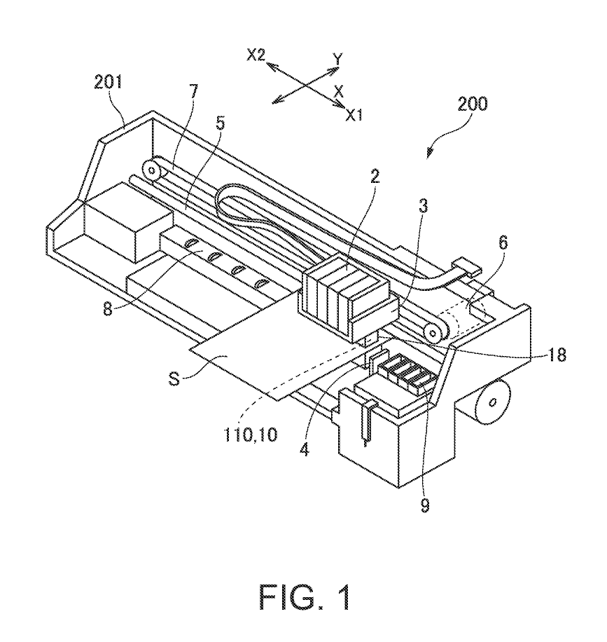

FIG. 1 an explanatory view of the liquid droplet discharge device related to Embodiment 1 of the invention. In FIG. 1, a liquid droplet discharge device 200 of the present embodiment is an ink jet printer that discharges liquid ink to a surface of a recoding medium S such as recording paper to record images or the like. The liquid droplet discharge device 200 includes a head assembly 110 including a plurality of liquid droplet discharge heads 10, a carriage 3 to which the head assembly 110 is attached, a carriage shaft 5 that supports the carriage 3 so as to be movable in the main scanning direction X, a platen 8 that transports the recording medium S in the auxiliary scanning direction Y or the like. The ink is stored in the ink cartridge 2, and the ink cartridge 2 and the head assembly 110 are mounted on the carriage 3. In addition, it is also possible to adopt a configuration in which the ink cartridge 2 is placed on a main body 201 side of the liquid droplet discharge device 200, and the ink is supplied to the liquid droplet discharge head 10 from the ink cartridge 2 through an ink supply tube. The carriage 3 is connected to a timing belt 7, and the timing belt 7 is driven by a pulse motor 6 such as a DC motor. Thus, when the pulse motor 6 is operated, the carriage 3 is guided to the carriage shaft 5, and moves back and forth in the main scanning direction X (the width direction of the recording medium S).

Herein, at a position corresponding to a home position of the carriage 3, that is, a cap member 9 which seals the liquid droplet discharge surface of the liquid droplet discharge head 10 is provided near one end portion of the carriage shaft 5. A suction unit (not shown) configured to suck the inside of the cap member is connected to the cap member 9. In the present embodiment, a plurality of cap members 9 is provided in response to the number of the liquid droplet discharge heads 10. The cap member 9 seals the liquid droplet discharge surface of the liquid droplet discharge head 10, thereby to prevent the ink from drying near the nozzle holes of the liquid droplet discharge head 10. Furthermore, the cap member 9 functions as an ink receiver when performing the flushing operation of ejecting the ink droplet from the nozzle holes or the suction operation of sucking the inside of the cap member 9 using the suction unit at a predetermined timing to forcibly discharge the ink or the like from the nozzle holes.

Furthermore, in the present embodiment, the wiping member 4 which is constituted by a cleaning blade or the like that wipes the liquid droplet discharge surface of the liquid droplet discharge head 10 is provided adjacent to the cap member 9. Thus, when bringing the leading end portion of the wiping member 4 into slide-contact with the liquid droplet discharge surface of the liquid droplet discharge head 10, by moving the carriage 3 at the predetermined timing, it is possible to carry out the cleaning operation of wiping the liquid droplet discharge surface.

### Configuration of Liquid Droplet Discharge Head 10

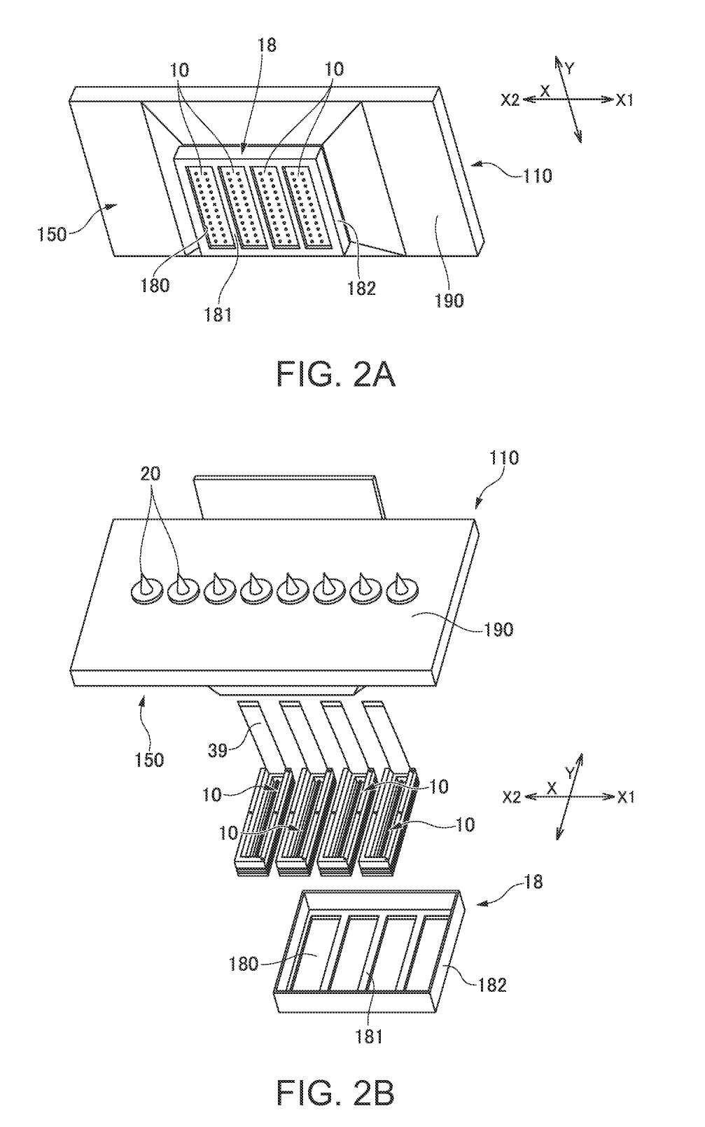

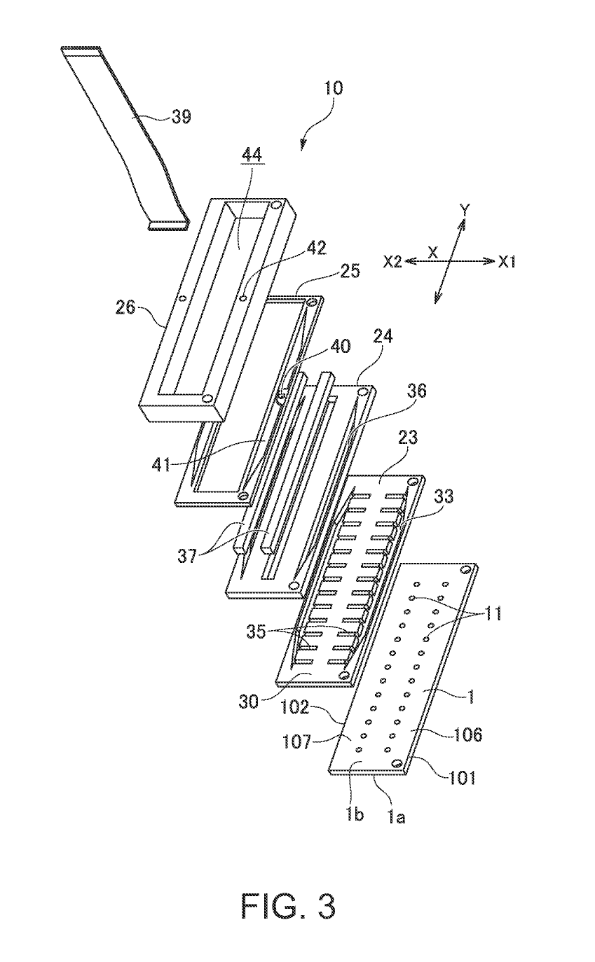

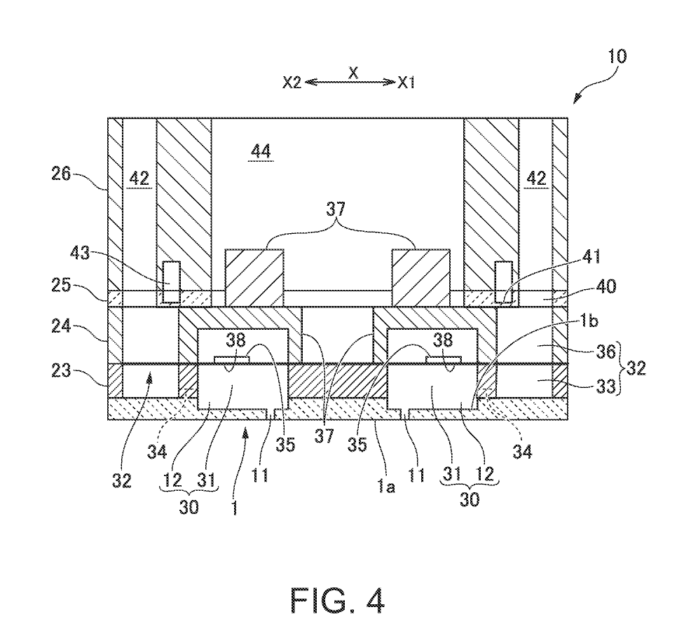

FIGS. 2A and 2B are explanatory views of the head assembly 110 used for the liquid droplet discharge device 200 related to Embodiment 1 of the invention, FIG. 2A is a perspective view of the head assembly 110, and FIG. 2B is an exploded perspective view of the head assembly 110. FIG. 3 is an exploded perspective view of the liquid droplet discharge head 10 related to Embodiment 1 of the invention. FIG. 4 is a cross-sectional view that schematically shows the configuration of the liquid droplet discharge head 10 related to Embodiment 1 of the invention.

As shown in FIGS. 2A and 2B, in the liquid droplet discharge device 200 of the present embodiment, a plurality of liquid droplet discharge heads 10 is mounted on the carriage 3 as the head assembly 110. The head assembly 110 is generally constituted by a case 150 as a head supporter, the plurality of liquid droplet discharge heads 10, and a fixing plate 18. The case 150 is a box-like member that accommodates the liquid droplet discharge head 10 therein, and a needle holder 190 is formed on an upper surface side thereof. The needle holder 190 is a plate-like member for attaching an ink introduction needle 20, and in the present embodiment, eight ink introduction needles 20 are uniformly disposed on the needle holder 190 in response to the ink color of the ink cartridge 2. The ink introduction needle 20 is a hollow needle-like member inserted into the ink cartridge 2, and is configured to introduce the ink stored in the ink cartridge 2 from an introduction hole (not shown) provided on the leading end portion into the liquid droplet discharge head 10 through a convergence flow path in the case 150.

On the bottom surface side of the case 150, four liquid droplet discharge heads 10 are placed in the state of being uniformly positioned in the main scanning direction X, and each of the four liquid droplet discharge heads 10 is directed to a long side in the main scanning direction X. Each of the four liquid droplet discharge heads 10 is fixed to the case 150 using the metallic fixing plate 18. The fixing plate 18 has a bottom plate portion 181 formed with four opening portions 180 at positions corresponding to the liquid droplet discharge head 10, and a side plate portion 182 that is bent at a right angle from an outer edge of the bottom plate portion 181, and is fixed to the liquid droplet discharge head 10 by an adhesive or the like.

As shown in FIGS. 3 and 4, the liquid droplet discharge head 10 is generally constituted from the nozzle plate 1, a cavity plate 23, a sealing substrate 24, and a compliance substrate 25, and is attached to a unit case 26 in the state of stacking these members.

The nozzle plate 1 is constituted by a silicon single crystalline substrate in which the plurality of circular nozzle holes 11 is arranged in the auxiliary scanning direction Y at a pitch corresponding to the dot formation concentration, and a liquid droplet discharge surface 1a is formed by the one surface thereof. In the present embodiment, two rows of the nozzle rows are formed by providing 180 nozzle holes 11 in rows at a pitch of 600 dpi. Herein, the nozzle plate 1 is a rectangular plate material, and a long side thereof is directed in the main scanning direction X. Thus, the nozzle holes 11 are arranged in the auxiliary scanning direction Y to form the nozzle row, and the two nozzle rows are arranged in parallel in the main scanning direction X.

The cavity plate 23 is manufactured with the silicon single crystalline substrate, such as the nozzle plate 1. On the upper surface (the surface of the sealing substrate 24 side) of the cavity plate 23, a thin elastic film 38 formed of silicon dioxide is formed by the thermal oxidation.

Such a cavity plate 23 is bonded to the nozzle plate to form a plurality of pressure chambers 30 having a one-to-one relationship with each of the plurality of nozzle holes 11 between the nozzle plate 1. For this reason, on the surface of the nozzle plate 1 side of the cavity plate 23, a first groove-shaped cavity 31 for forming the pressure chamber 30 is formed. Furthermore, in the present embodiment, as will be described later, on the surface 1b of the cavity plate 23 side of the nozzle plate 1, a second groove-shaped cavity 12 forming the pressure chamber 30 and the first groove-shaped cavity 31 is formed.

In the cavity plate 23, a communicated space portion 33 configured to partition a part of the common liquid chamber 32 as a chamber into which the common ink is introduced is formed outside the first groove-shaped cavity 31. The communicated space portion 33 communicates with each pressure chamber 30 via an ink supply path 34. Furthermore, a piezoelectric element 35 is provided for each of the pressure chambers 30 on the elastic film 38, and such a piezoelectric element 35 has a structure in which a metallic lower electrode film, a piezoelectric layer formed of lead zirconate titanate (PZT) or the like, and an upper electrode film made of a metal are sequentially stacked. The piezoelectric element 35 is a piezoelectric vibrator of a so-called bending mode, and is formed so as to cover the upper portion of the pressure chamber 30.

On the cavity plate 23 formed with the piezoelectric element 35, the sealing substrate 24 having a penetrated space portion 36 penetrating in the thickness direction is placed. The sealing substrate 24 is manufactured with the use of the silicon single crystalline substrate, like the cavity plate 23 and the nozzle plate 1. The penetrated space portion 36 in the sealing substrate 24 communicates with a communicated space portion 33 of the cavity plate 23 to partition a part of the common liquid chamber 32. On the upper surface (the surface of an opposite side to the cavity plate 23) of the sealing substrate 24, a drive IC 37 for driving each piezoelectric element 35 is provided. Each terminal of the drive IC 37 is connected to an extraction wiring extracted from the individual electrodes of each piezoelectric element 35 via a bonding wire (not shown) or the like. Moreover, each terminal of the drive IC 37 is electrically connected to a control unit (not shown) of the liquid droplet discharge device 200 via an external wiring 39 such as a flexible print cable (FPC), and various signals such as the print signal from the control unit side are supplied via the external wiring 39.

The compliance substrate 25 is placed on the upper surface side of the sealing substrate 24. In a region in the compliance substrate 25 facing the penetrated space portion 36 of the sealing substrate 24, an ink introduction port 40 for supplying the ink from the ink introduction needle 20 side to the common liquid chamber 32 is formed so as to penetrate in the thickness direction. Furthermore, a region other than the ink introduction port 40 of the region facing the penetrated space portion 36 of the compliance substrate 25 is a flexible portion 41 formed extremely thin, and the upper opening of the penetrated space portion 36 is sealed by the flexible portion 41, whereby the common liquid chamber 32 is partitioned and formed. Such a flexible portion 41 functions as a compliance portion that absorbs the pressure fluctuation of the ink in the common liquid chamber 32.

The unit case 26 is a member in which an ink introduction path 42 for supplying the ink introduced from the ink introduction needle 20 side (see FIG. 2B) to the common liquid chamber 32 side in communication with the ink introduction port 40 is formed, and a concave portion 43 adapted to permit the expansion of the flexible portion 41 is formed in a region facing the flexible portion 41. In the central portion of the unit case 26, specifically, in a region facing the drive IC 37 provided on the sealing substrate 24, a space portion 44 penetrating in the thickness direction is opened, and the external wiring 39 is inserted through the space portion 44 and is connected to the drive IC 37.

The nozzle plate 1, the cavity plate 23, the sealing substrate 24, the compliance substrate 25, and the unit case 26 are joined to one another, by placing an adhesive, a thermal welding film or the like therebetween and being heated in the stacked state, thereby to constitute the liquid droplet discharge head 10.

The liquid droplet discharge head 10 configured in this manner is attached to the carriage 3 so that the row direction of the nozzle holes 11 is matched with the auxiliary scanning direction Y in the state of the head assembly 110. Moreover, each liquid droplet discharge head 10 takes the ink from the ink cartridge 2 to the common liquid chamber 32 via the ink introduction path 42 and the ink introduction port 40, and fills the ink flow path (a kind of the liquid flow path) from the common liquid chamber 32 to the nozzle hole 11 with the ink. Moreover, by supplying the drive signal from the drive IC 37 to the piezoelectric element 35 and performing the bending deformation of the piezoelectric element 35, the pressure fluctuation is caused in the ink in the corresponding pressure chamber 30, and the liquid droplet of the ink is discharged from the nozzle hole 11 by the use of the pressure fluctuation of the ink.

### Detailed Configuration of Pressure Chamber 30

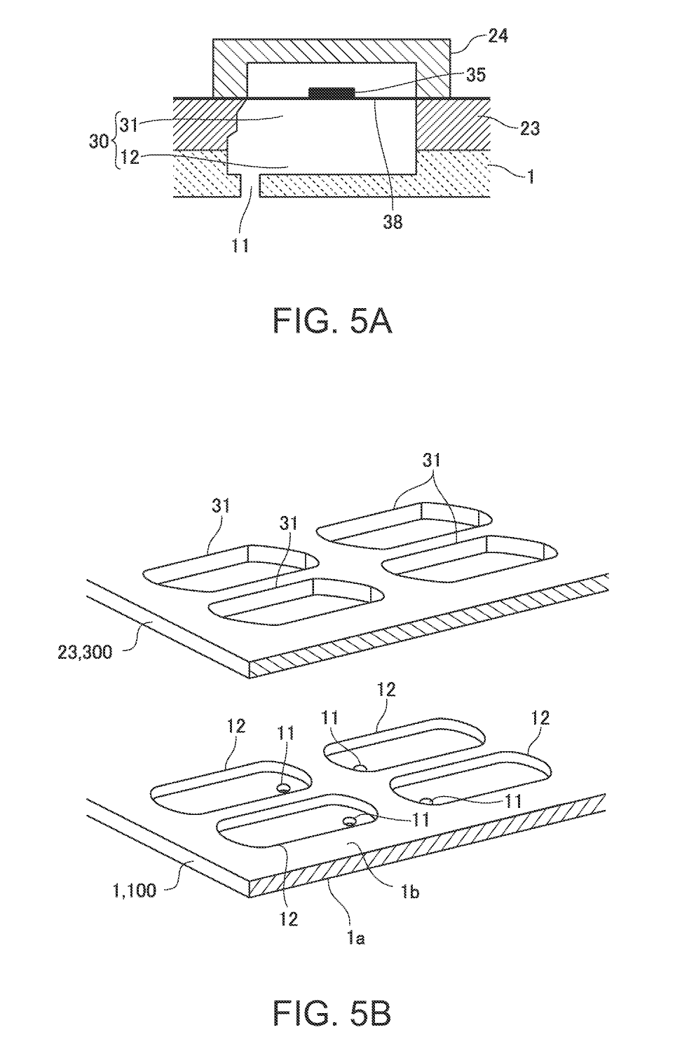

FIGS. 5A and 5B are explanatory views of the pressure chamber 30 formed in the liquid droplet discharge head 10 related to Embodiment 1, enlarged explanatory views of the pressure chamber 30, and explanatory views that show an aspect in which the pressure chamber 30 is constituted by the first groove-shaped cavity 31 and the second groove-shaped cavity 12. In addition, in FIG. 5B, the elastic film 38 is not shown.

As shown in FIGS. 5A and 5B, in the liquid droplet discharge head 10 of the present embodiment, the pressure chamber 30 includes the first groove-shaped cavity 31 formed on the surface of the nozzle plate 1 side of the cavity plate 23, and the second groove-shaped cavity 12 that is formed on the surface 1b of the cavity plate 23 side of the nozzle plate 1 and communicates with the nozzle hole 11 in the bottom portion thereof. In the present embodiment, the first groove-shaped cavity 31 is formed as a penetration portion that penetrates the silicon single crystalline substrate forming the cavity plate 23, and an opening portion of an opposite side to the nozzle plate of such a penetration portion is blocked by the elastic film 38.

On the contrary, the second groove-shaped cavity 12 is formed as a concave portion with a bottom opened in the surface 1b of the nozzle plate 1, and the nozzle hole 11 is opened in the bottom portion of such a concave portion. Herein, the second groove-shaped cavity 12 is formed by the dry etching of the silicon single crystalline substrate for the nozzle plate, and is formed in a long hole shape extending in the main scanning direction X. On the contrary, the first groove-shaped cavity 31 is formed by the anisotropic wet etching of the silicon single crystalline substrate for the cavity plate, and in the anisotropic wet etching, the etching speed differs depending on the crystal orientation. For example, a plane orientation (111) uses properties that is hard to be etched. For this reason, the second groove-shaped cavity 12 is formed in a long hole shape extending in the main scanning direction X, and a part of the side surface thereof becomes a tapered surface under the influence of the crystal orientation. However, both the first groove-shaped cavity 31 and the second groove-shaped cavity 12 have a length size of approximately 500 μm, and a width size of 20 to 25 μm. Thus, since the first groove-shaped cavity 31 and the second groove-shaped cavity 12 form the pressure chamber 30 with sufficient overlap, the capacity of the pressure chamber 30 is great.

### Main Effects of Present Embodiment

In this manner, in the present embodiment, the first groove-shaped cavity 31 is formed on the cavity plate 23, the second groove-shaped cavity 12 is formed on the nozzle plate 1, in addition to the nozzle holes 11, and when bonding the cavity plate 23 and the nozzle plate 1 to each other, the first groove-shaped cavity 31 and the second groove-shaped cavity 12 overlap each other to form the pressure chamber 30. For this reason, it is possible to form the pressure chamber 30 having the great capacity using the two members. Therefore, it is possible to prevent an increase in viscosity of the discharged liquefied substance (ink) in the pressure chamber 30 due to the evaporation of the solvent.

Furthermore, when expanding the pressure chamber 30 in the thickness direction, although an area of the wall surface interposed between the adjacent pressure chambers 30 increases and the crosstalk easily occurs, in the present embodiment, since the pressure chambers 30 is expanded in an in-plane direction, even when the capacity of the pressure chamber 30 is expanded, the area of the wall surface interposed between the adjacent pressure chambers 30 is small. Therefore, there is an advantage in that, even when the capacity of the pressure chamber 30 is expanded, the crosstalk hardly occurs.

Furthermore, since the first groove-shaped cavity 31 is formed by the wet etching, and the nozzle holes 11 are formed by the dry etching, the cavity plate 23 can be effectively manufactured, and it is possible to manufacture the nozzle plate 1 having the excellent shape accuracy or the like of the nozzle holes 11.

### Summary of Method of Manufacturing Liquid Droplet Discharge Head 10

In order to manufacture the liquid droplet discharge head 10 described referring to FIGS. 4, 5A and 5B, a cavity plate manufacturing process that forms the first groove-shaped cavity 31 on the substrate 300 for the cavity plate to obtain the cavity plate 23 is performed. Furthermore, a nozzle plate manufacturing process is performed which forms the nozzle holes 11 on the substrate 100 for the nozzle plate, and forms the second groove-shaped cavity 12 communicating with the nozzle holes 11 in the bottom portion on one surface of the substrate 100 for the nozzle plate, thereby to obtain the nozzle plate 1. Moreover, a bonding process is performed which bonds the nozzle plate 1 and the cavity plate 23 to each other so that the first groove-shaped cavity 31 and the second groove-shaped cavity 12 overlap to form the pressure chamber 30. Thus, the detailed contents of the cavity plate manufacturing process and the nozzle plate manufacturing process will be described below.

### Method of Manufacturing Cavity Plate 23

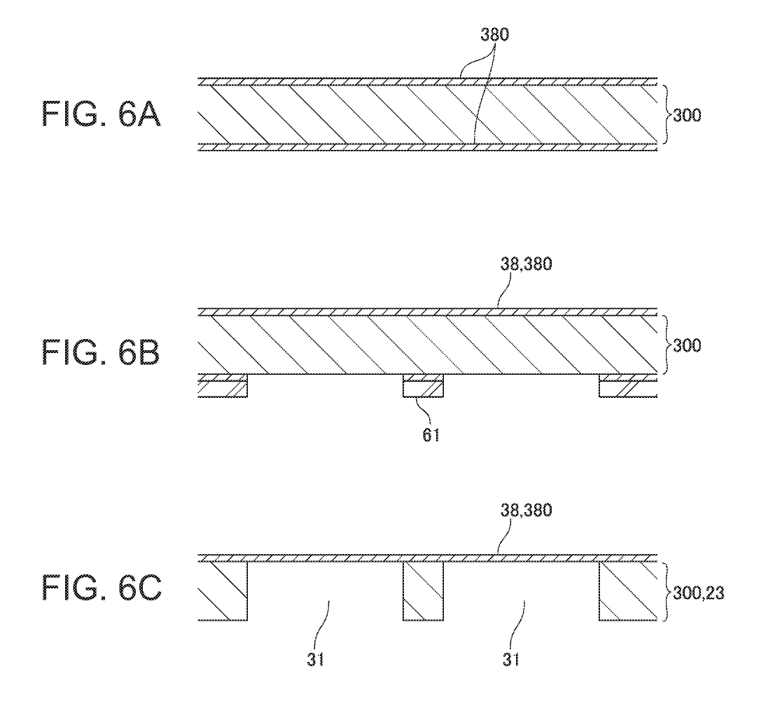

FIGS. 6A to 6C are process cross-sectional views that show a method of manufacturing the cavity plate 23 shown in FIGS. 5A and 5B. In addition, in FIGS. 6A to 6C, in both surfaces of the cavity plate 23 (the substrate 300 for the cavity plate), the side formed with the elastic film 38 is shown upward.

In order to manufacture the cavity plate 23 of the liquid droplet discharge head 10 shown in FIGS. 5A and 5B, first, the substrate 300 for the cavity plate shown in FIG. 6A is prepared. The substrate 300 for the cavity plate is a silicon single crystalline substrate having the surface of (110) plane orientation, and is a large silicon substrate that is able to take a plurality of the cavity plates 23. Thus, in the present embodiment, each process described below is performed, the first groove-shaped cavity 31 or the like is formed in each of the plurality of regions surrounded by a cutting-projected line in the substrate 300 for the cavity plate, and then the substrate 300 for the cavity plate is cut along the cutting-projected line, thereby to manufacture the plurality of the cavity plates 23.

More specifically, first, the substrate 300 for the cavity plate is subjected to the thermal oxidation, thereby to form the silicon oxide film 380 on both surfaces of the substrate 300 for the cavity plate.

Next, as shown in FIG. 6B, a resist mask 61 is formed on the surface of the silicon oxide film 380 formed on one surface of both surfaces of the substrate 300 for the cavity plate, and the silicon oxide film 380 of one surface side is patterned by the method such as the dry etching. In addition, the silicon oxide film 380 is not patterned on the other surface side of the substrate 300 for the cavity plate, but is used as the elastic film 38.

Next, the substrate 300 for the cavity plate is immersed in the etching liquid such as potassium hydroxide-based etching liquid, the substrate 300 for the cavity plate is subjected to the wet etching from an opening hole portion 61a of the resist mask 61, as shown in FIG. 6C, the first groove-shaped cavity 31 is formed, and then, the silicon oxide film 380 and the resist mask 61 formed on one surface of the substrate 300 for the cavity plate are removed. At that time, the communicated space portion 33 shown in FIG. 4 or the like is also formed.

Furthermore, apart from the wet etching of the first groove-shaped cavity 31, unnecessary portions except for the formation of the ink supply path 34 shown in FIG. 4 and a location used as the elastic film 38 in the silicon oxide film 380 are removed.

Next, the substrate 300 for the cavity plate is cut to manufacture the plurality of cavity plates 23.

### First Example of Method of Manufacturing Nozzle Plate 1

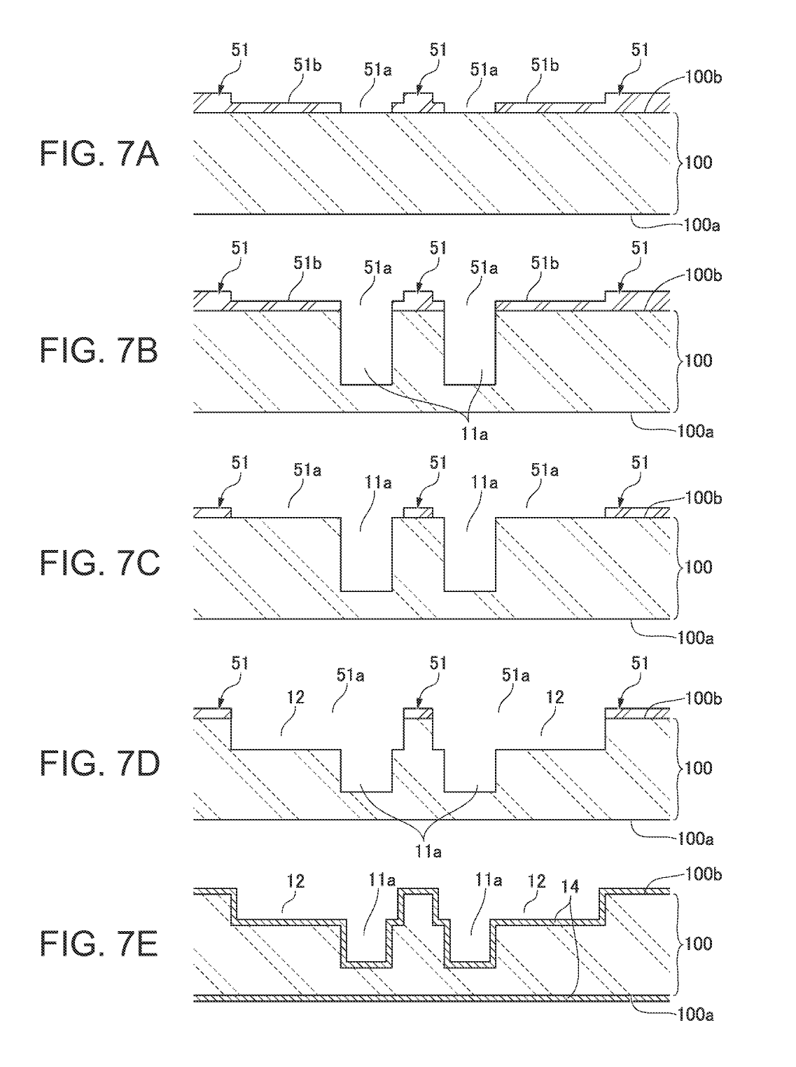

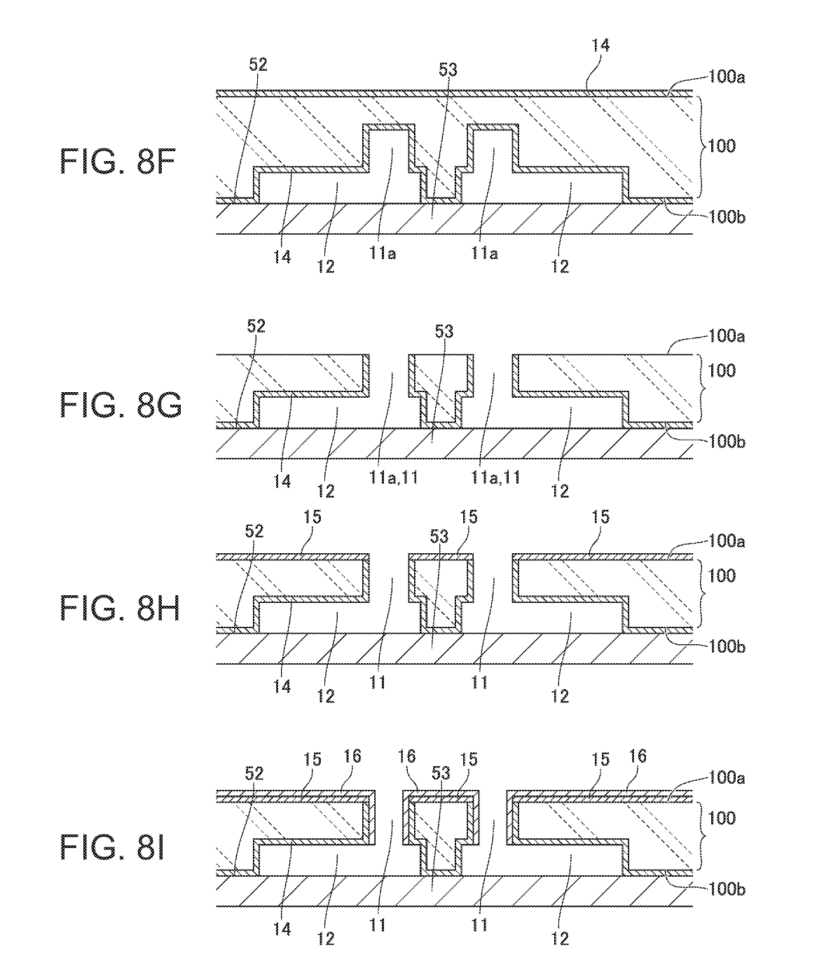

FIGS. 7A to 7E are process cross-sectional views that show a first example of the method of manufacturing the nozzle plate 1 shown in FIGS. 5A and 5B. FIGS. 8F to 8I are process cross-sectional views that show the manufacturing process of the nozzle plate 1 performed subsequent to FIGS. 7A to 7E. In addition, in FIGS. 7A to 7E, in the first surface 100a and the second surface 100b of the substrate 100 for the nozzle plate, the first surface 100a serving as the liquid droplet discharge surface 1a when forming the nozzle plate 1 is shown downward, and in FIGS. 8F to 8I, the first surface 100a is shown upward. Furthermore, in the following description, the term “main surface of the substrate 100 for the nozzle plate” in the invention corresponds to the second surface 100b (the surface of the side formed with the second groove-shaped cavity 12) of the substrate 100 for the nozzle plate, and the term “back surface of the substrate 100 for the nozzle plate” corresponds to the first surface 100a (the side serving as the liquid droplet discharge surface 1a) of the substrate 100 for the nozzle plate.

In order to manufacture the nozzle plate 1 of the liquid droplet discharge head 10 shown in FIGS. 5A and 5B, first, the substrate 100 for the nozzle plate shown in FIG. 7A is prepared. Similar to the substrate 300 for the cavity plate shown in FIGS. 6A to 6C, the substrate 100 for the nozzle plate is also a silicon single crystalline substrate and is a large silicon substrate where a plurality of the nozzle plates 1 can be located. Thus, in the present embodiment, each process described below is performed, the nozzle hole 11, the second groove-shaped cavity 12 or the like is formed in each of the plurality of regions surrounded by the cutting-projected line in the substrate 100 for the nozzle plate, and then, the substrate 100 for the nozzle plate is cut along the cutting-projected line, thereby to manufacture the plurality of the nozzle plates 1.

More specifically, first, an etching mask 51 is formed on the second surface 100b of the substrate 100 for the nozzle plate. Such an etching mask 51 is formed of a silicon oxide film, and the forming-projected area of the nozzle hole 11 is an opening hole portion 51a. Furthermore, the etching mask 51 is configured so that a forming-projected area of the second groove-shaped cavity 12 is a thin film portion 51b. For example, such an etching mask 51 can be formed, by forming the silicon oxide film on the entire surface of the substrate 100 for the nozzle plate using the thermal oxidation method, and then repeating the etching in the state of forming the resist mask on the silicon oxide film.

Next, in the etching process for the nozzle hole, as shown in FIG. 7B, the anisotropic dry etching is performed perpendicularly to the second surface 100b of the substrate 100 for the nozzle plate from the opening hole portion 51a of the etching mask 51 using an ICP dry etching device (not shown), thereby to form the concave portion 11a for the nozzle hole. As the etching gas of this case, C₄F₈ gas and SF₆ gas are used, and such etching gases are alternately used. Herein, the C₄F₈ gas is used so as to protect the side surface so that etching does not proceed to the side surface of the concave portion 11a for the nozzle hole, and the SF₆ gas is used so as to promote etching of the substrate 100 for the nozzle plate in the vertical direction.

Next, as shown in FIG. 7C, the half-etching is performed by the buffering hydrofluoric aqueous solution, the thin firm portion 51b is removed, and the opening hole portion 51a is expanded.

Next, in the etching process for the cavity, as shown in FIG. 7D, the anisotropic dry etching is performed perpendicularly to the second surface 100b of the substrate 100 for the nozzle plate from the opening hole portion 51a of the etching mask 51, using an ICP dry etching device (not shown), the second groove-shaped cavity 12 is formed, and then the etching mask 51 is removed by the hydrofluoric aqueous solution or the like.

Next, as shown in FIG. 7E, the liquid-resistant protective film 14 having the ink-resistant properties is formed on the entire surface of the substrate 100 for the nozzle plate. In the present embodiment, the substrate 100 for the nozzle plate is input to a thermal oxidation furnace, and a thermal oxide film (SiO₂ film), for example, having a film thickness of 0.1 μm is formed on the entire surface of the substrate 100 for the nozzle plate as the liquid-resistant protective film 14.

Next, as shown in FIG. 8F, a support substrate 53 formed of a transparent material such as a glass is bonded to the second surface 100b of the substrate 100 for the nozzle plate via a double-sided bonding sheet 52. The double-sided bonding sheet 52 is a sheet (self-peeling type sheet) having a self-peeling layer, has a bonding surface on the both sides thereof, and further has a self-peeling layer on one surface thereof. Adhesive force of such a self-peeling layer drops due to stimulations such as ultraviolet ray or heat.

Next, in the thinning process shown in FIG. 8G, by cutting the substrate 100 for the nozzle plate from the first surface 100a side, the substrate 100 for the nozzle plate is thinned, and the nozzle holes 11 are formed through the concave portion 11a for the nozzle hole. When performing the thinning process, in the present embodiment, after performing the grinding work or the polishing work on the first surface 100a side of the substrate 100 for the nozzle plate, cleaning is performed. For example, the first surface 100a of the substrate 100 for the nozzle plate is subjected to the grinding work using a back grinder (not shown). In addition, in the thinning process, the first surface 100a may be polished by a polisher and a CMP device to thin the substrate 100 for the nozzle plate. Furthermore, the substrate 100 for the nozzle plate may be thinned by etching.

Next, as shown in FIG. 8H, a liquid-resistant protective film 15 formed of the silicon oxide film or the like is formed on the first surface 100a of the substrate 100 for the nozzle plate using the sputtering method or the like. At that time, the process may be performed at a temperature (approximately, 200° C.) in which the double-sided bonding sheet 52 is not degraded or less, and the method is not limited to the sputtering method. However, there is a need to form a dense film when considering the ink-resistant properties or the like, and it is preferable to use a device capable of forming the dense film at a normal temperature, such as an ECR sputtering device.

Next, as shown in FIG. 8I, the liquid repellent treatment for allowing the substrate 100 for the nozzle plate to have the liquid repellent properties with respect to the ink is performed. Specifically, the liquid repellent material including a silicon compound containing fluorine atoms as a main ingredient is used to form a film on the first surface 100a of the substrate 100 for the nozzle plate by the method such as a vapor deposition, and the liquid repellent layer 16 is formed on the entire first surface 100a of the substrate 100 for the nozzle plate. In addition, as the liquid repellent layer 16, after forming a molecular film of metal alkoxide containing fluorine, the layer may be formed through the drying process, the annealing process or the like.

Thereafter, the UV beam is irradiated from the side of the support substrate 53 to peel off the double-sided bonding sheet 52 from the substrate 100 for the nozzle plate, and the support substrate 53 is detached from the substrate 100 for the nozzle plate. In addition, the Ar sputtering or the O₂ plasma treatment may be performed from the second surface 100b side of the substrate 100 for the nozzle plate, thereby to remove the liquid repellent layer 16 attached to the inner walls of the second groove-shaped cavity 12 and the nozzle hole 11.

Thereafter, after bonding the dicing tape to the first surface 100a or the second surface 100b of the substrate 100 for the nozzle plate, the substrate 100 for the nozzle plate is cut, and the nozzle plate 1 is peeled off from the dicing tape, thereby to obtain the nozzle plate 1.

### Second Example of Method of Manufacturing Nozzle Plate 1

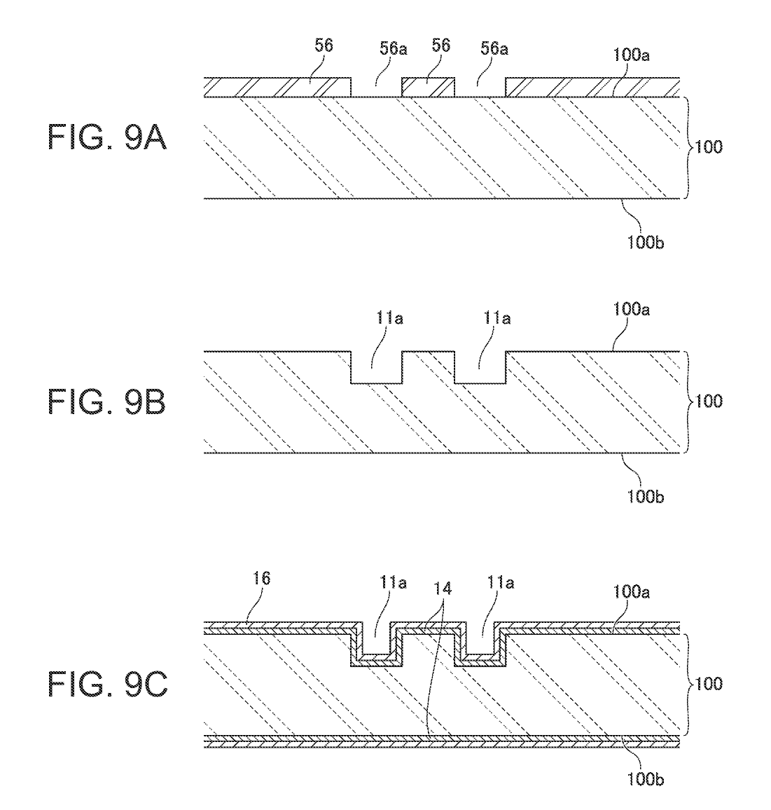

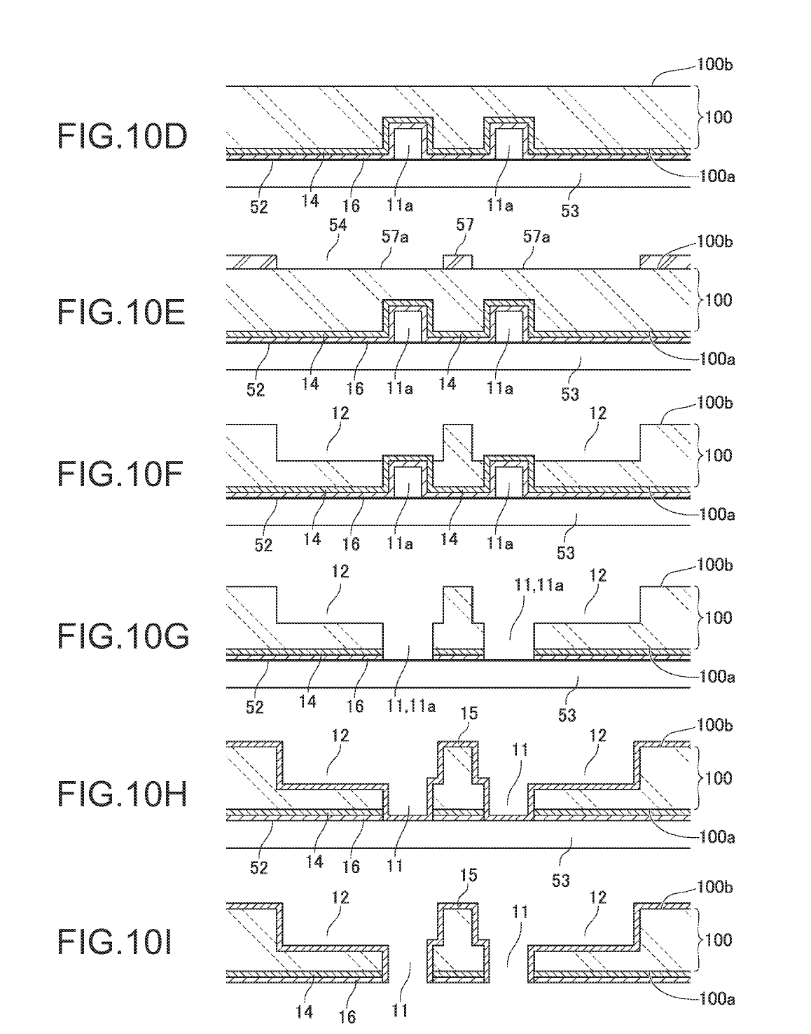

FIGS. 9A to 9C are process cross-sectional views that show a second example of the method of manufacturing the nozzle plate 1 shown in FIGS. 5A and 5B. FIGS. 10D to 10I are process cross-sectional views that show the manufacturing process of the nozzle plate 1 performed subsequent to FIGS. 9A to 9C. In addition, in FIGS. 9A to 9C, in the first surface 100a and the second surface 100b of the substrate 100 for the nozzle plate, the first surface 100a serving as the liquid droplet discharge surface 1a when forming the nozzle plate 1 is shown upward, and in FIGS. 10D to 10I, the first surface 100a is shown downward.

In order to manufacture the nozzle plate 1 of the liquid droplet discharge head 10 shown in FIGS. 5A and 5B, first, the substrate 100 for the nozzle plate shown in FIG. 9A is prepared. The substrate 100 for the nozzle plate is a large silicon single crystalline substrate that is able to take a plurality of the nozzle plates 1. When manufacturing the nozzle plate 1 using the substrate 100 for the nozzle plate, in the present embodiment, first, an etching mask 56 formed of a resist mask is formed on the first surface 100a of the substrate 100 for the nozzle plate. Next, in the etching process for the nozzle hole, the first surface 100a of the substrate 100 for the nozzle plate is etched via the opening hole portion 56a of the etching mask 56, as shown in FIG. 9B, the concave portion 11a for the nozzle hole is formed, and then the etching mask 54 is removed by the sulfuric acid treatment or the like. As such etching, in the present embodiment, the anisotropic dry etching is performed on the first surface 100a of the substrate 100 for the nozzle plate using an ICP dry etching device (not shown), thereby to form the concave portion 11a for the nozzle hole perpendicularly to the first surface 100a. As the etching gas for this case, C₄F₈ gas and SF₆ gas are used, and such etching gases are alternately used.

Next, as shown in FIG. 9C, the liquid-resistant protective film 14 is formed on the entire surface of the substrate 100 for the nozzle plate. In the present embodiment, the substrate 100 for the nozzle plate is input to a thermal oxidation furnace, and a thermal oxide film (SiO₂ film), for example, having a film thickness of 0.1 μm is formed on the entire surface of the substrate 100 for the nozzle plate as the liquid-resistant protective film 14.

Next, the liquid repellent material including a silicon compound containing fluorine atoms as a main ingredient is used to form a film on the entire surface of the substrate 100 for the nozzle plate by a method such as immersion, and the liquid repellent layer 16 is formed on the entire surface of the substrate 100 for the nozzle plate. At this time, the liquid repellent layer 16 is also formed on the inner wall of the concave portion 11a for the nozzle hole.

Next, as shown in FIG. 10D, the support substrate 53 formed of a transparent material such as a glass is bonded to the first surface 100a of the substrate 100 for the nozzle plate via the double-sided bonding sheet 52. In this manner, by cutting the substrate 100 for the nozzle plate from the second surface 100b side, the substrate 100 for the nozzle plate is thinned. When performing the thinning process, in the present embodiment, after performing the grinding work or the polishing work on the second surface 100b side of the substrate 100 for the nozzle plate, cleaning is performed. For example, the second surface 100b of the substrate 100 for the nozzle plate is subjected to the grinding work using a back grinder (not shown). In addition, in the thinning process, the second surface 100b may be polished by a polisher and a CMP device to thin the substrate 100 for the nozzle plate. Furthermore, the substrate 100 for the nozzle plate may be thinned by etching.

Next, as shown in FIG. 10E, an etching mask 57 formed of a resist mask is formed on the second surface 100b of the substrate 100 for the nozzle plate. Next, in the etching process for the cavity, the second surface 100b of the substrate 100 for the nozzle plate is etched via the opening hole portion 57a of the etching mask 57, as shown in FIG. 10F, the second groove-shaped cavity 12 is formed, and then the etching mask 55 is removed by the sulfuric acid treatment or the like. As the etching gas of this case, C₄F₈ gas and SF₆ gas are used, and such etching gases are alternately used.

Next, as shown in FIG. 10G, the liquid-resistant protective film 14 is subjected to the wet etching using the hydrofluoric aqueous solution or the like, thereby to remove the liquid-resistant protective film 14 exposed in the bottom portion of the second groove-shaped cavity 12, and remove the liquid-resistant protective film 14 formed on the inner wall of the concave portion 11a for the nozzle hole. As a result, the concave portion 11a for the nozzle hole penetrates, and the nozzle holes 11 are formed.

Next, as shown in FIG. 10H, the liquid-resistant protective film 15 formed of the silicon oxide film or the like is formed on the second surface 100b of the substrate 100 for the nozzle plate using the sputtering method or the like. At that time, the process may be performed at a temperature (approximately, 200° C.) in which the double-sided bonding sheet 52 is not degraded or less, and the method is not limited to the sputtering method. However, there is a need to form a dense film when considering the ink-resistant properties or the like, and it is preferable to use a device capable of forming the dense film at a normal temperature, such as an ECR sputtering device.

Next, the UV beam is irradiated from the side of the support substrate 53 to peel off the double-sided bonding sheet 52 from the substrate 100 for the nozzle plate, and as shown in FIG. 10I, the support substrate 53 is detached from the substrate 100 for the nozzle plate.

Thereafter, after bonding the dicing tape to the first surface 100a or the second surface 100b of the substrate 100 for the nozzle plate, the substrate 100 for the nozzle plate is cut, and the nozzle plate 1 is peeled off from the dicing tape, thereby to obtain the nozzle plate 1.

### Third Example of Method of Manufacturing Nozzle Plate 1

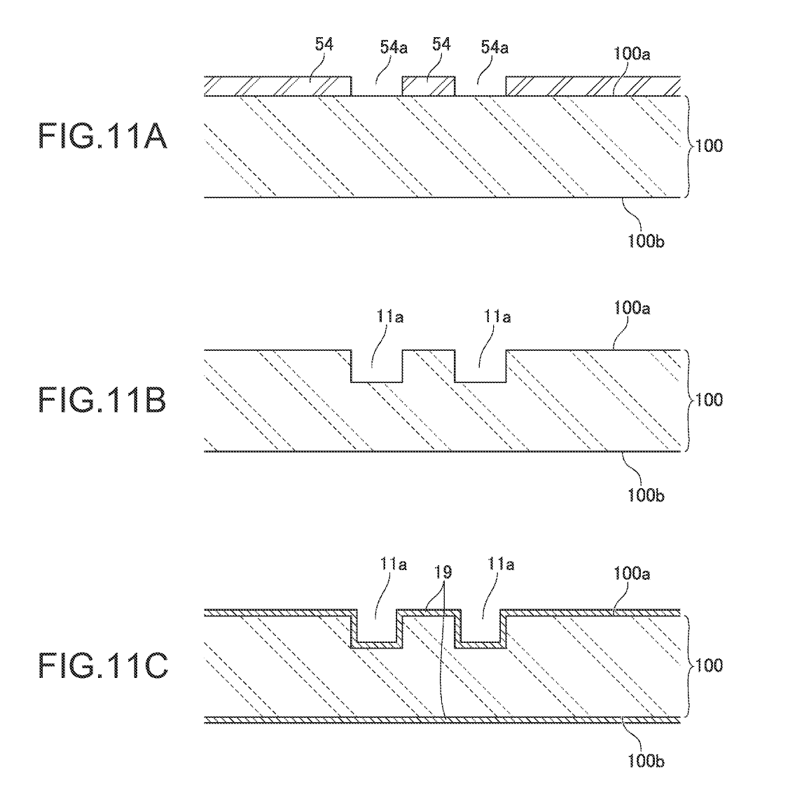

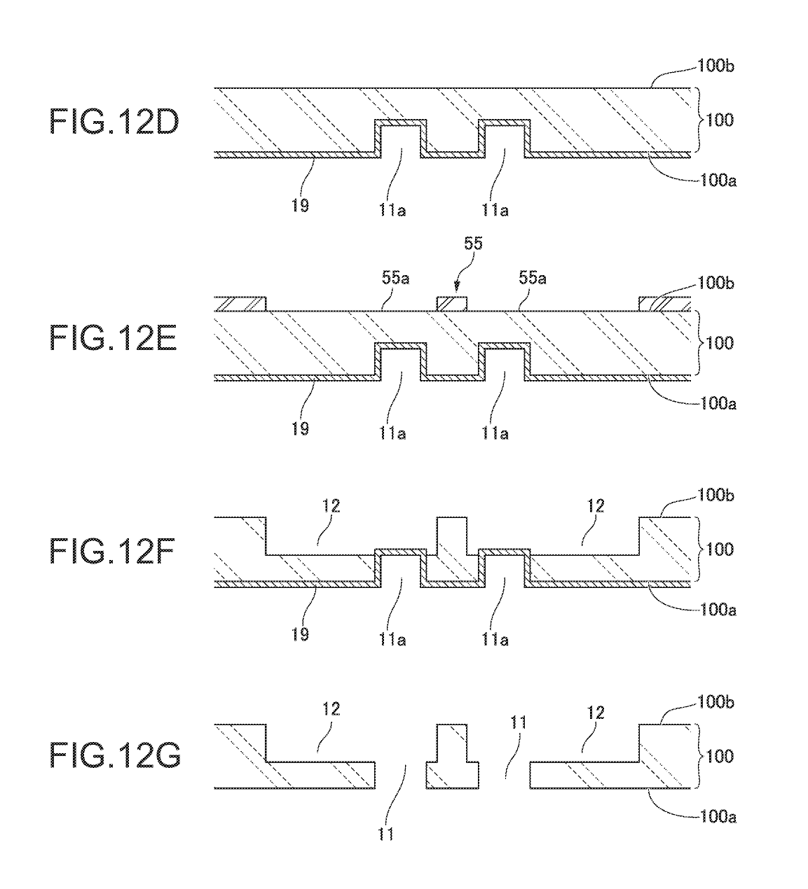

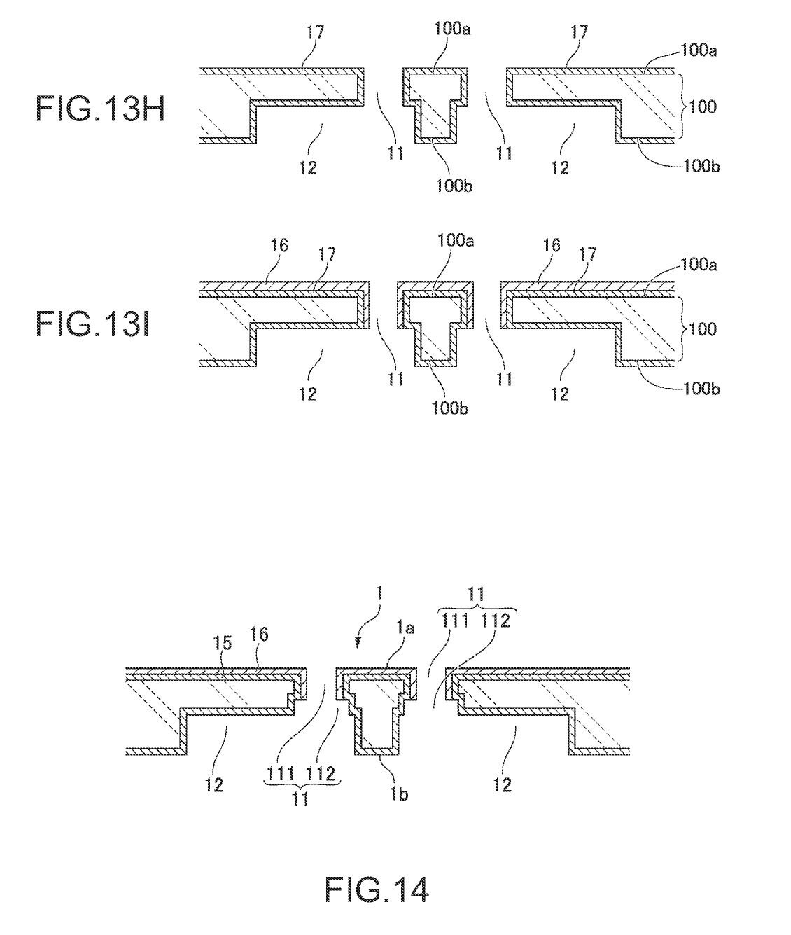

FIGS. 11A to 11C are process cross-sectional views that show a third example of the method of manufacturing the nozzle plate 1 shown in FIGS. 5A and 5B. FIGS. 12D to 12G are process cross-sectional views that show the manufacturing process of the nozzle plate 1 performed subsequent to FIGS. 11A to 11C. FIGS. 13H and 13I are process cross-sectional views that show the manufacturing process of the nozzle plate 1 performed subsequent to FIGS. 12D to 12G. In addition, in FIGS. 11A to 11C and 13H and 13I, in the first surface 100a and the second surface 100b of the substrate 100 for the nozzle plate, the first surface 100a serving as the liquid droplet discharge surface 1a when forming the nozzle plate 1 is shown upward, and in FIGS. 12D to 12G, the first surface 100a is shown downward.

In order to manufacture the nozzle plate 1 of the liquid droplet discharge head 10 shown in FIGS. 5A and 5B, first, the substrate 100 for the nozzle plate shown in FIG. 11A is prepared. The substrate 100 for the nozzle plate is a large silicon single crystalline substrate that is able to take a plurality of the nozzle plates 1. When manufacturing the nozzle plate 1 using the substrate 100 for the nozzle plate, in the present embodiment, first, an etching mask 54 formed of a resist mask is formed on the first surface 100a of the substrate 100 for the nozzle plate. Next, in the etching process for the nozzle hole, the first surface 100a of the substrate 100 for the nozzle plate is etched via the opening hole portion 54a of the etching mask 54, as shown in FIG. 11B, the concave portion 11a for the nozzle hole is formed, and then the etching mask 54 is removed by the sulfuric acid treatment or the like. As such etching, in the present embodiment, the anisotropic dry etching is performed on the first surface 100a of the substrate 100 for the nozzle plate using an ICP dry etching device (not shown), thereby to form the concave portion 11a for the nozzle hole perpendicularly to the first surface 100a. As the etching gas of this case, C₄F₈ gas and SF₆ gas are used, and such etching gases are alternately used.

Next, as shown in FIG. 110, a protective film 19 is formed on the entire surface of the substrate 100 for the nozzle plate. In the present embodiment, the substrate 100 for the nozzle plate is input to a thermal oxidation furnace, and a thermal oxide film (SiO₂ film), for example, having a film thickness of 0.1 μm is formed on the entire surface of the substrate 100 for the nozzle plate as the protective film 19.

Next, in the thinning process shown in FIG. 12D, by cutting the substrate 100 for the nozzle plate from the second surface 100b side, the substrate 100 for the nozzle plate is thinned. When performing the thinning process, in the present embodiment, after performing the grinding work or the polishing work on the second surface 100b side of the substrate 100 for the nozzle plate, cleaning is performed. For example, the second surface 100b of the substrate 100 for the nozzle plate is subjected to the grinding work using a back grinder (not shown). In addition, in the thinning process, the second surface 100b may be polished by a polisher and a CMP device to thin the substrate 100 for the nozzle plate. Furthermore, the substrate 100 for the nozzle plate may be thinned by etching.

Next, as shown in FIG. 12E, an etching mask 55 formed of a resist mask is formed on the second surface 100b of the substrate 100 for the nozzle plate. Next, in the etching process for the cavity, the second surface 100b of the substrate 100 for the nozzle plate is etched via the opening hole portion 55a of the etching mask 55, as shown in FIG. 12F, the second groove-shaped cavity 12 is formed, and then the etching mask 55 is removed by the sulfuric acid treatment or the like. As the etching gas of this case, C₄F₈ gas and SF₆ gas are used, and such etching gases are alternately used.

Next, as shown in FIG. 12G, the protective film 19 is subjected to the wet etching using the hydrofluoric aqueous solution or the like, thereby to remove the protective film 19. As a result, the concave portion 11a for the nozzle hole penetrates, and the nozzle holes 11 are formed.

Next, as shown in FIG. 13H, the liquid-resistant protective film 17 having ink-resistant properties is formed on the entire surface of the substrate 100 for the nozzle plate including the inner walls of the nozzle holes 11. In the present embodiment, the substrate 100 for the nozzle plate is input to a thermal oxidation furnace, and a thermal oxide film (SiO₂ film), for example, having a film thickness of 0.1 μm is formed on the entire surface of the substrate 100 for the nozzle plate as the liquid-resistant protective film 17.

Next, as shown in FIG. 13I, the liquid repellent material including a silicon compound containing fluorine atoms as a main ingredient is used to form a film on the first surface 100a of the substrate 100 for the nozzle plate by the method such as the vapor deposition, and the liquid repellent layer 16 is formed on the entire first surface 100a of the substrate 100 for the nozzle plate. At this time, the liquid repellent layer 16 is also formed on the inner walls of the nozzle holes 11.

Thereafter, after bonding the dicing tape to the first surface 100a or the second surface 100b of the substrate 100 for the nozzle plate, the substrate 100 for the nozzle plate is cut, and the nozzle plate 1 is peeled off from the dicing tape, thereby to obtain the nozzle plate 1.

### Embodiment 2

FIG. 14 is an enlarged cross-sectional view showing an aspect in which a nozzle plate 1 of a liquid droplet discharge head 10 of a liquid droplet discharge device 200 related to Embodiment 2 of the invention is cut in the main scanning direction X. In addition, since basic configurations of the present embodiment are the same as those of Embodiment 1, the common portions are denoted by the same reference numerals, and the descriptions thereof will be omitted. Furthermore, in FIG. 14, the liquid droplet discharge surface 1a of both surfaces of the nozzle plate 1 is shown upward.

In Embodiment 1, although the nozzle holes 11 have approximately the same internal radius and penetrate through the nozzle plate 1, in the present embodiment, as shown in FIG. 14, the nozzle holes 11 have a nozzle portion formed in a cylindrical shape of two stages having different diameters. More specifically, the nozzle hole 11 includes a small-diameter first nozzle portion (a small-diameter hole of an injection port portion) 111, a leading end of which is opened to the liquid droplet discharge surface 1a, and a large-diameter second nozzle portion (a large-diameter hole of an introduction hole portion) 112 that communicates with the first nozzle portion 111 on the surface 1b side and is opened to the surface 1b. The first nozzle portion and the second nozzle portion 112 are provided perpendicularly with respect to the substrate surface, and are coaxially formed. For this reason, since the discharge direction of the ink droplet can be arranged in the central axis direction of the nozzle holes 11, the stable ink discharge characteristics are exhibited. In the present embodiment, for example, the internal diameter of the first nozzle portion 111 is 15 to 30 μm, and the internal diameter of the second nozzle portion 112 is an approximately 1.5 times the internal diameter of the first nozzle portion 111.

In the nozzle plate 1 of such a configuration, similar to Embodiment 1 or the like, the second groove-shaped cavity 12 is also formed on the back surface of the nozzle plate 1, and as described referring to FIGS. 4, 5A and 5B, the second groove-shaped cavity 12 forms the pressure chamber 30 and the first groove-shaped cavity 31 of the cavity plate 23.

### Other Embodiment

Although the liquid droplet discharge head 10 of the liquid droplet discharge device 200 using the piezoelectric element has been described in the above-mentioned embodiments, the invention is not limited to the above-mentioned embodiments, but can be variously changed within the scope of the technical idea of the invention. For example, the invention may be applied to the liquid droplet discharge head 10 that uses electrostatic force, a heater element or the like as driving means. Furthermore, the invention can be applied to a liquid droplet discharge device other than an ink jet printer, by changing the liquefied material discharged from the nozzle holes 11.

The entire disclosure of Japanese Patent Application No. 2012-094518, filed Apr. 18, 2012 is expressly incorporated by reference herein.

What is claimed is:

1. A method of manufacturing a liquid droplet discharge head that includes a nozzle plate having nozzle holes, a cavity plate joined to the nozzle plate, and a pressure chamber communicating with the nozzle holes, the method comprising:
forming a first groove-shaped cavity on a substrate for the cavity plate to obtain the cavity plate;
forming the nozzle holes on a substrate for the nozzle plate and forming a second groove-shaped cavity communicating with the nozzle holes on a main surface of the substrate for the nozzle plate to obtain the nozzle plate; and
stacking the first groove-shaped cavity and the second groove-shaped cavity and bonding the nozzle plate and the cavity plate to each other to form the pressure chamber.

2. The method of manufacturing a liquid droplet discharge head according to claim 1,
wherein the first groove-shaped cavity is formed by wet etching in the forming of the cavity plate, and
the nozzle holes are formed by dry etching in the forming of the nozzle plate.

3. The method of manufacturing a liquid droplet discharge head according to claim 1,
wherein, in the forming of the nozzle plate,
forming a concave portion on the main surface of the substrate for the nozzle plate by etching,
forming the second groove-shaped cavity on the main surface by etching, and
thinning by cutting the substrate for the nozzle plate from a back surface the substrate with respect to the main surface, and causing the concave portion to pass through as the nozzle holes are performed.

4. The method of manufacturing a liquid droplet discharge head according to claim 1,
wherein, in the forming of the nozzle plate,
forming a concave portion on the back surface with respect to the main surface of the substrate for the nozzle plate by etching,
thinning by cutting the substrate for the nozzle plate from the main surface, and
forming the second groove-shaped cavity on the main surface of the substrate for the nozzle cavity by etching are performed.

5. A liquid droplet discharge head comprising:
a cavity plate having a first cavity as a through hole; and
a nozzle plate having nozzle holes formed on a first surface and a second cavity formed on a second surface of an opposite side to the first surface, the nozzle holes communicating with the second cavity,
wherein the nozzle plate and the cavity plate are bonded to each other on the second surface of the nozzle plate, and
the nozzle hole, the first cavity and the second cavity communicate with one another.

6. A method of manufacturing a liquid droplet discharge head, comprising:
forming a first cavity as a through hole on a first substrate to obtain a cavity plate;
forming nozzle holes on a first surface of a second substrate, and forming a second cavity on a second surface of an opposite side to the first surface of the second substrate to obtain a nozzle plate, the nozzle holes communicating with the second cavity; and
bonding the second surface of the nozzle plate and the cavity plate to each other.

7. The method of manufacturing a liquid droplet discharge head according to claim 6,
wherein the first cavity is formed by wet etching, and
the nozzle holes are formed by dry etching.

8. The method of manufacturing a liquid droplet discharge head according to claim 6,
wherein the forming of the nozzle plate includes
forming a concave portion on the first surface of the second substrate by etching,
forming the second cavity on the first surface by etching, and
forming the nozzle holes by cutting the second substrate from the second surface and perforating the concave portion.

9. The method of manufacturing a liquid droplet discharge head according to claim 6,
wherein the forming the nozzle plate includes
forming the concave portion on the first surface of the second substrate by etching,
grinding the second substrate from the second surface, and
forming the second cavity on the second surface of the second substrate by etching.

10. A liquid droplet discharge device including the liquid droplet discharge head according to claim 5.
